(19) United States
(12) Patent Application Publication
(10) Pub. No.: US 2023/0047187 A1
(43) Pub. Date: Feb. 16, 2023

(54) EXTRANEOUS VOICE REMOVAL FROM AUDIO IN A COMMUNICATION SESSION

(71) Applicant: Avaya Management L.P., Durham, NC (US)

(72) Inventors: Pushkar Yashavant Deole, Pune (IN); Sandesh Chopdekar, Pune (IN); Navin Daga, Silapathar (IN)

(21) Appl. No.: 17/398,527

(22) Filed: Aug. 10, 2021

(51) Int. Cl. G10L 21/0272; G10L 17/04; G10L 25/27; G06N 20/00

(52) U.S. Cl. CPC G10L 21/0272; G10L 17/04; G10L 25/27; G06N 20/00

(57) ABSTRACT

The technology disclosed herein enables removal of extraneous voices from audio in a communication session. In a particular embodiment, a method includes receiving audio captured from an endpoint operated by a user on a communication session. The method further includes identifying an extraneous voice in the audio, wherein the voice is from a person other than the user, and removing the extraneous voice from the audio. After removing the extraneous voice, the method includes transmitting the audio to another endpoint on the communication session.

### TECHNICAL BACKGROUND

When two or more users are speaking over a real-time communication session, a user's endpoint may capture sound other than the user's voice. That sound, when sent over the communication session, may interfere with other users' experience on the session. For instance, the sound may be distracting to the other users or may prevent the other users from understanding the user properly (e.g., the other sound may drown out the user's voice). Some communication systems implement noise reduction mechanisms that help minimize the sound discussed above. However, those noise reduction features are limited to common sounds like dogs barking, birds chirping, noise of construction activity, drilling, noise of table/ceiling fans, noise of AC compressor, noise of hammering, noise of vehicles passing by, etc. Should the user's endpoint capture another person's voice, that voice will evade typical noise reduction mechanisms and interfere with the communication session.

### SUMMARY

The technology disclosed herein enables removal of extraneous voices from audio in a communication session. In a particular embodiment, a method includes receiving audio captured from an endpoint operated by a user on a communication session. The method further includes identifying an extraneous voice in the audio, wherein the voice is from a person other than the user, and removing the extraneous voice from the audio. After removing the extraneous voice, the method includes transmitting the audio to another endpoint on the communication session.

In some embodiments, identifying and removing the extraneous voice comprise inputting the audio into a machine learning algorithm, wherein the machine learning algorithm is trained to recognize a user voice of the user and wherein the machine learning algorithm outputs the audio with the extraneous voice removed.

In some embodiments, the method includes training the machine learning algorithm using one or more samples of the user voice. In response to the user joining the communication session, some embodiments include requesting the samples from the user. In some embodiments, training the machine learning algorithm uses one or more extraneous voice samples that were not intended for transmittal.

The machine learning algorithm may generate a confidence score for the extraneous voice and removes the extraneous voice upon determining that the confidence score satisfies a threshold level of confidence. The machine learning algorithm may consider intensity of the extraneous voice and/or a language spoken by the extraneous voice when generating the confidence score.

In some embodiments, the method includes notifying the user that the extraneous voice has been identified and removing the extraneous voice is performed in response to determining that the user has granted permission for removal of the extraneous voice.

In some embodiments, identifying the extraneous voice comprises isolating the extraneous voice from one or more other voices in the audio.

In some embodiments, the extraneous voice is not a voice included in a whitelist of voices.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to receive audio captured from an endpoint operated by a user on a communication session. The program instructions further direct the processing system to identify an extraneous voice in the audio, wherein the voice is from a person other than the user, and remove the extraneous voice from the audio. After removing the extraneous voice, the program instructions direct the processing system to transmit the audio to another endpoint on the communication session.

### BRIEF DESCRIPTION OF THE DRAWINGS

FIG. 1 illustrates an implementation for removing extraneous voices from audio in a communication session.

FIG. 2 illustrates an operation to remove extraneous voices from audio in a communication session.

FIG. 3 illustrates an operational scenario for removing extraneous voices from audio in a communication session.

FIG. 4 illustrates an operational scenario for removing extraneous voices from audio in a communication session.

FIG. 5 illustrates an operation to remove extraneous voices from audio in a communication session.

FIG. 6 illustrates an operation to remove extraneous voices from audio in a communication session.

FIG. 7 illustrates a computing architecture for removing extraneous voices from audio in a communication session.

### DETAILED DESCRIPTION

During a communication session exchanging user communications for two or more users, one or more extraneous voices captured by an endpoint on the communication session are removed from the audio transferred to other endpoints on the communication session. Specifically, the one or more voices are voices of users other than a user participating in the communication session. A voice other than the participating user's voice, therefore, does not interfere with the communication session when the audio is presented at the other endpoints. For example, a user may be participating in a communication session at home and members of the user's family may be home with the user. If the user is unable to find a quiet place to participate, then voices from the user's family may also be captured by the user's endpoint. Those other voices are removed from the audio when transmitted to other endpoints.

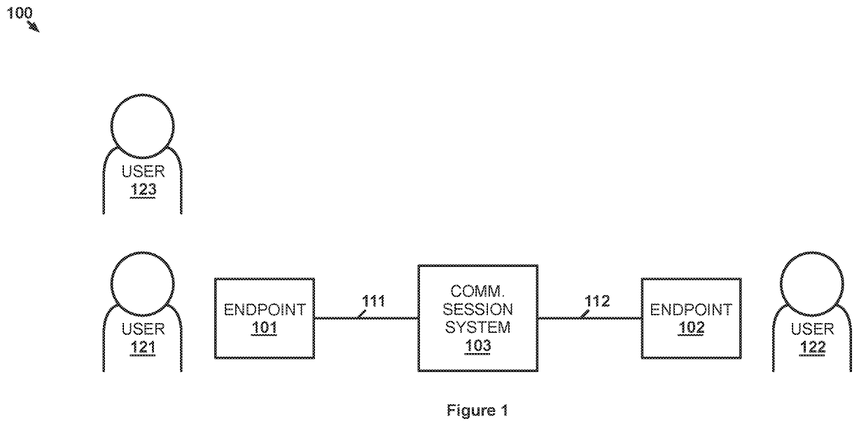

FIG. 1 illustrates implementation 100 for removing extraneous voices from audio in a communication session. Implementation 100 includes endpoint 101, endpoint 102, and communication session system 103. User 121 operates endpoint 101 and user 122 operates endpoint 102. Endpoint 101 and communication session system 103 communicate over communication link 111. Endpoint 102 and communication session system 103 communicate over communication link 112. Communication links 111-112 may be wired links, wireless links, or some combination thereof. Communication links 111-112 are shown as direct links but may include intervening systems, networks, and/or devices.

In operation, endpoint 102 and endpoint 103 may each respectively be a telephone, tablet computer, laptop computer, desktop computer, conference room system, or some other type of computing device capable of connecting to a communication session facilitated by communication session system 103. Communication session system 103 facilitates communication sessions between two or more endpoints, such as endpoint 101 and endpoint 102. In some examples, communication session system 103 may be omitted in favor of a peer-to-peer communication session between endpoint 101 and endpoint 102. A communication session includes at least an audio channel between endpoint 101 and endpoint 102 (e.g., for voice communications) but may also include a video channel (e.g., for video communications), a graphic component (e.g., presentation slides, screen sharing, etc.), text chat component, and/or some other type of real-time communication. Other examples may include more than two participants and/or more than two endpoints on the communication session.

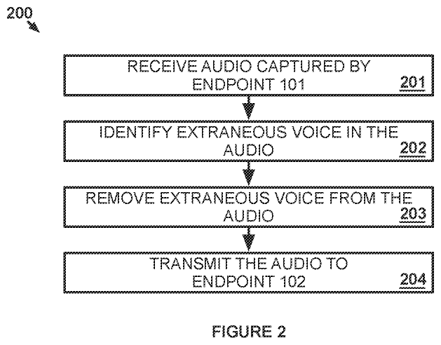

FIG. 2 illustrates operation 200 to remove extraneous voices from audio in a communication session. Operation 200 occurs while endpoint 101 and endpoint 102 are endpoints on a real-time communication session there between facilitated by communication session system 103. Operation 200 includes receiving audio captured from endpoint 101 (201). The audio is audio that is captured for transmission in real-time over the communication session so that user 121 and user 122 can hear each other in real-time. The audio represents sound captured by endpoint 101 at the location of endpoint 101. If user 121 is speaking, then the audio includes user 121's voice. Other sounds at endpoint 101, including voices, may also be included in the audio captured by endpoint 101. Operation 200 may be performed by endpoint 101, endpoint 102, communication session system 103, or some other system in the communication path between endpoint 101 and endpoint 102. Receiving the audio may, therefore, include endpoint 101 capturing the sound thereat to generate the audio or communication session system 103 receiving the audio from endpoint 101 over communication link 111.

Operation 200 further includes identifying an extraneous voice in the audio, wherein the voice is from a person other than the user (202). In this case, user 123 is located near enough to endpoint 101 that endpoint 101 was able to capture the sound of user 123's voice during the communication session. User 123's voice is, therefore, included in the audio even though user 123, unlike user 121, is a person who is not a participant on the communication session. For example, user 123 may be a relative of user 121's that is yelling something in another room loud enough for endpoint 101 to capture user 123's voice or user 123 may walk into the room with user 121 while talking on the phone during the communication session. In some examples, user 121's voice may be recognized and any voice that is not that of user 121 is considered extraneous. A predefined voice signature for user 121 may be stored for comparison to a signature generated for a voice in the audio to determine whether the voice is user 121's (i.e., matches the predefined signature) or is extraneous (i.e., does not match the predefined signature). In some examples, characteristics of extraneous voices and/or participant voices (e.g., intensity levels, language(s) used, etc.) may be stored for comparison to characteristics of voices in the audio. In some examples, a machine learning algorithm(s), including neural networks and deep learning, may be trained to recognize the voice of user 121 and/or recognize extraneous voices. Once trained, the machine learning algorithm becomes an artificial intelligence that is able to recognize extraneous voices. In some examples, the machine learning algorithm may be trained to recognize characteristics of a participant's voice that indicate it is extraneous in certain circumstances. As such, user 121's voice may be identified as extraneous at certain points during the communication session. For example, user 121 may forget to mute endpoint 101 and begins speaking to user 123 about something not intended for transmission over the communication session. User 121's voice may be identified as being extraneous in that situation even though they are the participant on the communication session.

The identified extraneous voice is removed from the audio (203). The extraneous voice may be removed by removing components (e.g., frequencies) corresponding to the extraneous voice from the audio. In some examples, removing the extraneous voice may not completely remove the extraneous voice but, rather, may attenuate the extraneous voice to a point where it will not, or is less likely, to interfere with user 122's experience on the communication session. In some examples, the machine learning algorithm discussed above may remove the identified extraneous voice rather than simply identifying the extraneous voice.

After removing the extraneous voice from user 123, the audio is transmitted to endpoint 102 over the communication session (204). Endpoint 102 receives the audio and plays the audio to user 122 in the same manner it would have had the extraneous voice not been removed. Since the removal of the extraneous voice occurs in real time, user 122 can still hear audio from endpoint 101 in real-time. In some examples, one or more additional noise reduction mechanisms may be used on the audio before transmission to endpoint 102 or even before the extraneous voice is identified and removed (e.g., to remove background noise captured at endpoint 101 in addition to the extraneous voice from user 123). While the audio is only sent to endpoint 102 in this example, additional endpoints may be on the communication session in other examples and the audio may be transmitted to those endpoints as well.

While the above example identifies only a single extraneous voice, other examples may identify and remove multiple extraneous voices if more than just user 123's voice is captured by endpoint 101. In those examples, voices captured by endpoint 101 may be mixed together (e.g., speaking at the same time). A neural network trained to isolate voices may be used on the audio to isolate the multiple voices. Each of the multiple voices can then be analyzed individually to determine whether they are extraneous. Similarly, there may be multiple participants at an endpoint in some examples. For instance, user 123 may be a participant on the communication session with user 121. As such, neither the voice of user 121 nor the voice of user 123 is extraneous. Operation 200 would, therefore, determine that voices other than user 121 and user 123's are extraneous. Also, while operation 200 only discusses the removal of extraneous voices from audio being transmitted to endpoint 102, extraneous voices may similarly be removed from audio being transmitted to endpoint 101 from endpoint 102.

In some examples, rather than always removing extraneous voices, the removal of extraneous voices may be toggled on and off by a user. For instance, endpoint 101 may present a graphical button or other type of toggle that user 121 may use to activate/deactivate the removal of extraneous voices on the communication session. User 121 may want to toggle off the removal of extraneous voices in the event that user 121 wants one or more other people, such as user 123, to participate in the communication session but does not want the other people's voices to potentially be removed as being extraneous. In some cases, user 122 may be presented with a similar toggle that allows user 122 to activate/deactivate the removal of extraneous voices from audio received from endpoint 101 (e.g., rather than having to ask user 121 to enable the removal on user 121's end). In those cases, user 122 may only be provided with the toggle because user 122 has a privilege that allows him to do so (e.g., user 122 may be an administrator or meeting chair/moderator).

While the examples herein discuss the removal of extraneous voices during a communication session, other scenarios may benefit from the removal of extraneous voices. For example, if user 121 is trying to record a message on endpoint 101, endpoint 101 may identify and remove user 123's voice prior to storing audio captured during the recording. The extraneous voices would, therefore, not be included when the stored audio is played back at a later time. In further examples, audio may be processed after storing to remove extraneous voices therein.

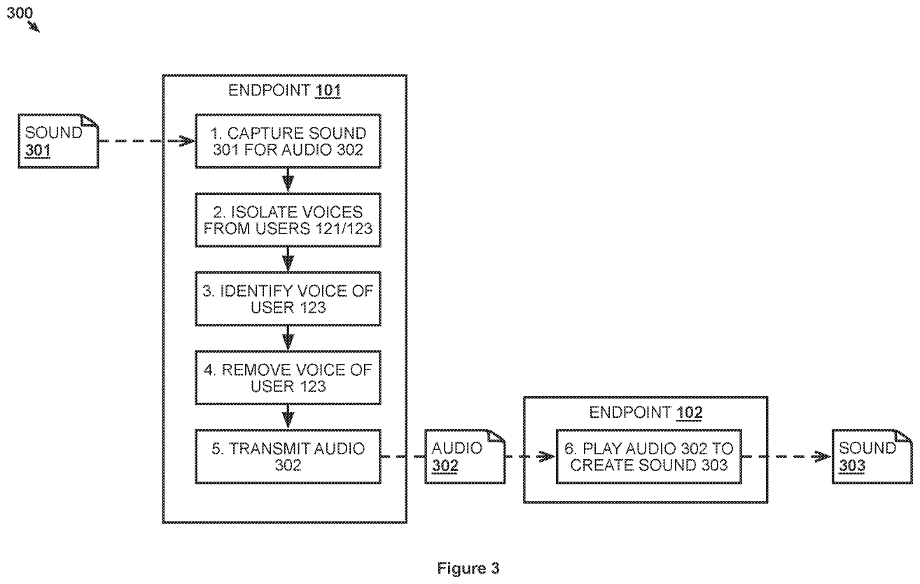

FIG. 3 illustrates operational scenario 300 for removing extraneous voices from audio in a communication session. In operational scenario 300, endpoint 101 identifies and removes extraneous voices from audio. Like in the examples above, endpoint 101 and endpoint 102 are endpoints on a real-time communication session for exchanging user communications of user 121 and user 122. Sound 301 is the sound occurring at the location of endpoint 101. Sound 301 may include the voice of user 121 when user 121 is speaking and the voice of user 123 when user 123 is speaking (i.e., only user 121 or user 123 may be speaking at any given time, both may be speaking at the same time, or neither may be speaking). Endpoint 101 captures sound 301 at step 1 to generate audio 302 for transmission over the communication session to endpoint 102. Audio 302 is a digital representation of sound 301. For example, endpoint 101 may use one or more microphones to capture sound 301 while an analog to digital converter converts the analog audio signal generated by the microphone(s) into a digital signal that can be processed by circuitry of endpoint 101.

Endpoint 101 isolates voices included in audio 302 at step 2. A neural network trained to separate voices within audio may be used by endpoint 101 to isolate voices in audio 302 or some other audio component isolation mechanism may be used instead. In this example, user 123 may be speaking at the same time that user 121 is speaking. Endpoint 101 isolates the voices of user 123 and user 121 so that the voices can be analyzed individually to determine which, if any, should be removed. In this case, endpoint 101 identifies the voice of user 123 as being extraneous at step 3 and removes the voice of user 123 from audio 302 at step 4. User 123's voice may be identified based on the voice having characteristics consistent with an extraneous voice, based on the voice not having characteristics consistent with a non-extraneous voice (e.g., user 121's voice), based on the voice not being user 121's voice (e.g., as indicated by a voice signature comparison), based on a determination made by an artificial intelligence (e.g., a trained machine learning algorithm), or using some other criteria—including combinations thereof.

After removing the voice of user 123 from audio 302, endpoint 101 transmits audio 302 over the communication session to endpoint 102 at step 5. Upon receipt of audio 302, endpoint 102 plays audio 302 to create sound 303 at step 6. For example, endpoint 102 may use a digital to analog converter to convert audio 302 to an analog signal that is used to drive a speaker(s) at endpoint 102. Although not shown, audio 302 may be transmitted through communication session system 103. In some examples, audio 302 may be encoded by endpoint 101 for transmission over the communication session and endpoint 102 decodes the encoded audio 302 before playback. While sound 301 included the extraneous voice of user 123 when captured by endpoint 101, sound 303 does not include the extraneous voice despite being a reproduction of sound 301 at endpoint 102 so that user 122 can hear user 121 speak.

It should be understood that all the steps described above continue in real-time during the communication session. That is, endpoint 101 is continually capturing sound 301, generating audio 302 therefrom, removing any extraneous voices that it identifies in audio 302, and transmitting audio 302 to endpoint 102 for playback. As such, since user 123 may not be speaking constantly during the communication session, endpoint 101 may not always have an extraneous voice to identify and remove from audio 302. When user 123 does begin talking such that their voice is captured from sound 301 in audio 302, then endpoint 101 identifies and removes user 123's voice from audio 302 before transmission to endpoint 102. User 123's voice would be removed upon determination that it is extraneous regardless of whether user 121 is speaking at the time (e.g., user 121 may be listening on the communication session without speaking when user 123 is talking).

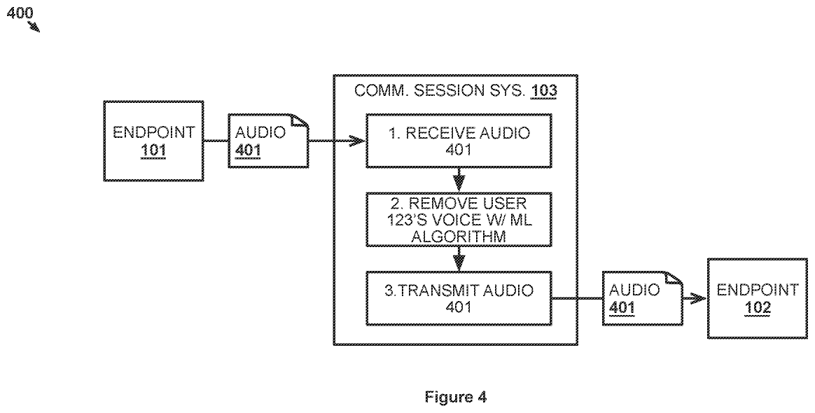

FIG. 4 illustrates operational scenario 400 for removing extraneous voices from audio in a communication session. In operational scenario 400, communication session system 103 identifies and removes extraneous voices from audio. Again endpoint 101 and endpoint 102 are endpoints on a real-time communication session facilitated by communication session system 103. Communication session system 103 receives audio 401 from endpoint 101 at step 1. Audio 401 was generated by endpoint 101 after capturing sound similar to how audio 302 was generated from capturing sound 301 above. Rather than endpoint 101 itself processing audio 401 to remove extraneous voices, endpoint 101 transmits audio 401 to communication session system 103 for processing.

Communication session system 103 receives audio 401 from endpoint 101 at step 1. While communication session system 103 could perform the same steps as endpoint 101 in operational scenario 300 to remove extraneous voices from audio 401, communication session system 103 uses the artificial intelligence of a machine learning algorithm to remove extraneous voices in this example. Specifically, audio 401 is provided as input into the machine learning algorithm at step 2 where the machine learning algorithm automatically identifies user 123's voice within audio 401 and removes user 123's voice from audio 401. In other examples, if another extraneous voice is included in audio 401 (e.g., from a third user at endpoint 101's location), the machine learning algorithm will remove that extraneous voice as well. After the machine learning algorithm removes user 123's voice from audio 401, communication session system 103 transmits audio 401 to endpoint 102 at step 3.

Like in operational scenario 300, endpoint 102 receives audio 401 and plays audio 401 to recreate the sound captured at endpoint 101 with the extraneous voice removed. Also like in operational scenario 300, the real-time nature of the communication session means that audio 401 is continually received and processed by the machine learning algorithm to remove any extraneous voices present therein. As such, the removal of extraneous voices does not interfere with user 121 and user 122's ability to speak with each other in real time.

While the examples of scenarios 300 and 400 describe different manners in which endpoint 101 and communication session system 103 identify and remove extraneous voices, elements of each scenario may be performed in the other. For example, in operational scenario 400, if the machine learning algorithm is incapable of isolating voices, then communication session system 103 may isolate voices in audio 401 prior to feeding the isolated voices into the machine learning algorithm.

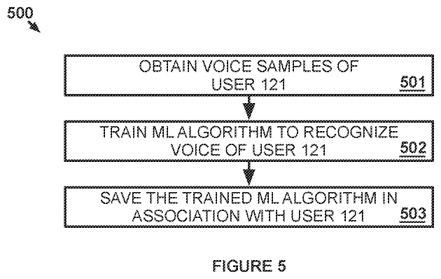

FIG. 5 illustrates operation 500 to remove extraneous voices from audio in a communication session. Operation 500 is an example of how a machine learning algorithm may be trained to recognize user 121's voice. Endpoint 101, communication session system 103, or some other system (e.g., a dedicated training system) may perform operation 500. In operation 500, samples of user 121 are obtained for input into the machine learning algorithm (501). The samples may be obtained from any source. The samples may include prerecorded audio of user 121's voice (e.g., audio recorded during previous communication sessions) or user 121 may be explicitly asked to provide the samples. In an example of the latter, endpoint 101 may prompt user 121 to speak certain words and/or phrases that are conducive to the machine learning algorithm's learning process. User 121 may provide the samples before initiating a communication session or may be prompted to provide the samples before joining a communication session, which may be beneficial, for example, when user 121 is not a regular user of communication session system 103.

The samples of user 121's voice are fed into the machine learning algorithm so that the machine learning algorithm can learn to recognize user 121 from future audio (502). In some examples, after an initial training phase using the samples, the machine learning algorithm may continue to learn based on additional audio of user 121's voice (e.g., audio of user 121's voice recognized during a communication session). The trained machine learning algorithm is saved in association with user 121 (503). The machine learning algorithm may be saved at endpoint 101, communication session system 103, or some other repository where the machine learning algorithm can be accessed later for use when identifying extraneous voices. For example, the trained machine learning algorithm may be stored in communication session system 103 so that the machine learning algorithm can be used to identify voices extraneous to user 121's voice regardless of the endpoint that user 121 uses to access communication session system 103. Similarly, if a machine learning algorithm trained to recognize user 123's voice was also stored, then that machine learning algorithm could be used to recognize user 123's voice if user 123 is supposed to be participating on the communication session with user 121 at endpoint 101. In those examples, voices that are not determined to be that of either user 121 or user 123 would be removed. In some examples, a user at endpoint 101 may indicate which users are participating thereat. This may effectively create a whitelist of users for which machine learning algorithms can be used to identify the voices thereof and identify voices other than those in the whitelist as being extraneous. A whitelist may also be used in non-machine learning algorithm examples as well (e.g., when audio signatures for the whitelisted voices are used).

While the machine learning algorithm above is trained to recognize a user's voice so that other voices can be removed for being extraneous, it should be understood that other manners of training the machine learning algorithm may be used instead of, or in addition to, using the voice samples described above. For example, the machine learning algorithm may be fed audio samples including voices of users that are not participants on a communication session (e.g., voices known to be background noise on previous communication sessions) so that the machine learning algorithm can learn to recognize, in a more general sense, voices that are not intended to be transmitted over a communication session (i.e., voices that are extraneous). Similarly, rather than learning to recognize a particular user, the machine learning algorithm may be fed audio samples of voices of participants on a communication session so that the machine learning algorithm can learn to recognize, in a more general sense, voices that are intended to be transmitted over a communication session (i.e., voices that are not extraneous).

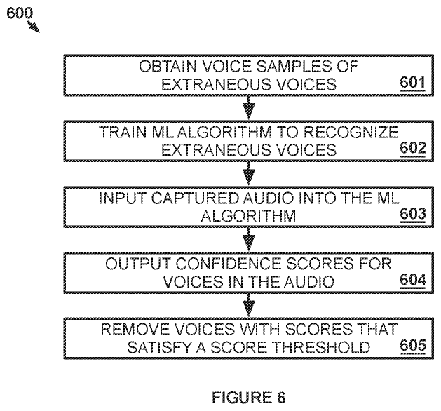

FIG. 6 illustrates operation 600 to remove extraneous voices from audio in a communication session. Operation 600 may be performed wholly in one system (e.g., endpoint 101 or communication session system 103) or may be divided among multiple systems (e.g., the training aspects may be performed in communication session system 103 while endpoint 101 uses the trained algorithm on captured audio). In operation 600, extraneous voice samples are received for training the machine learning algorithm (601). The extraneous voice samples may be prerecorded samples from previous communication sessions that are known to be extraneous. The extraneous voice samples are fed into the machine learning algorithm to train the machine learning algorithm to recognize extraneous voices (602). The machine learning algorithm automatically recognizes characteristics of the extraneous voices in the samples to build its artificial intelligence for recognizing voices later on having similar characteristics. The characteristics may include an intensity (e.g., loudness of the extraneous voice indicating that the voice is likely far away and not intended for transmission), the language used by the extraneous voice (e.g., relative to the language(s) being used on the communication session as may determined by a natural language processing algorithm), distortion in the voice (e.g., the voice may be muffled), the type of sound being made by the extraneous voice (e.g., yelling, normal speaking, crying, yawning, etc.), the words being spoken (e.g., are the words on topic for the session), or some other characteristic indicative of an extraneous voice. In some cases, the machine learning algorithm may also be fed non-extraneous voice samples to contrast their characteristics relative to the characteristics of the extraneous voice samples.

After training the machine learning algorithm, the machine learning algorithm can be used to identify extraneous voices. In this example, audio captured during a communication session is input into the machine learning algorithm (603). The machine learning algorithm identifies voices in the audio and outputs a confidence score for each of the voices (604). The confidence score for a particular voice indicates how confident the machine learning algorithm is that the voice is extraneous. The confidence score may be represented as a percentage (e.g., on a range of 0-100% confident), as a value between two predefined limits (e.g., 0-25, with 25 being the most confident), or may be represented in some other manner. For example, higher scores may indicate that the machine learning algorithm is very confident that the voice is extraneous while lower scores may indicate that the machine learning algorithm is not confident that the voice is extraneous (or does not think the voice is extraneous at all). Rules may be implemented to define characteristics and how much each characteristic should affect the confidence score either up or down. The confidence score may be affected by the number of extraneous voice characteristics that the machine learning algorithm identifies in a voice, a weight of the extraneous voice characteristics relative to each other (e.g., the voice using a different language from other voices on the conference session may have a higher confidence weight than the voice having a lower intensity), a feature of a particular characteristic (e.g., a very low intensity of a voice may indicate higher confidence than a merely slightly lower than average intensity), or some other manner in which confidence may be affected. In this example, every voice in the audio receives a confidence score with any voice that is not extraneous likely receiving a very low or 0 score. In other examples, the machine learning algorithm may first determine whether a voice is extraneous and then further indicate a confidence score with that extraneous voice. Any voice determined to not be extraneous would not receive a score and would not be subject to the threshold described below.

Voices associated with confidence scores that satisfy a confidence score threshold are removed from the audio because the satisfaction of the threshold indicates they are extraneous (605). The threshold may be defined by a user (e.g., user 121), may be predefined by communication session system 103, or may be defined from some other source. In some examples, the threshold may be adjusted even during a communication session. For example, if user 123 is supposed to be participating in the communication session at endpoint 101 along with user 121 but their voice is still being removed (i.e., identified as extraneous based on the voice's confidence score), then user 121 may adjust the threshold so that the confidence score of user 123's voice no longer satisfies the threshold.

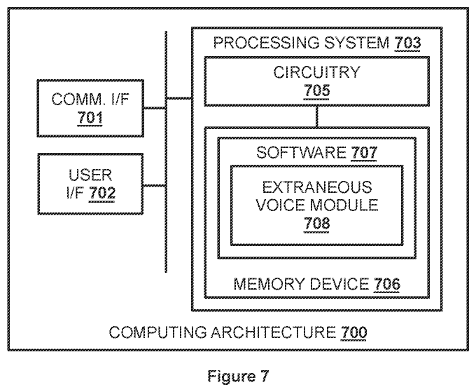

FIG. 7 illustrates computing architecture 700 for removing extraneous voices from audio in a communication session. Computing architecture 700 is an example computing architecture for endpoint 101, although endpoint 101 may use alternative configurations. Other computing systems herein, such as communication session system 103 and endpoint 102 may also use computing architecture 700. Computing architecture 700 comprises communication interface 701, user interface 702, and processing system 703. Processing system 703 is linked to communication interface 701 and user interface 702. Processing system 703 includes processing circuitry 705 and memory device 706 that stores operating software 707.

Communication interface 701 comprises components that communicate over communication links, such as network cards, ports, RF transceivers, processing circuitry and software, or some other communication devices. Communication interface 701 may be configured to communicate over metallic, wireless, or optical links. Communication interface 701 may be configured to use TDM, IP, Ethernet, optical networking, wireless protocols, communication signaling, or some other communication format—including combinations thereof.

User interface 702 comprises components that interact with a user. User interface 702 may include a keyboard, display screen, mouse, touch pad, or some other user input/output apparatus. User interface 702 may be omitted in some examples.

Processing circuitry 705 comprises microprocessor and other circuitry that retrieves and executes operating software 707 from memory device 706. Memory device 706 comprises a computer readable storage medium, such as a disk drive, flash drive, data storage circuitry, or some other memory apparatus. In no examples would a storage medium of memory device 706 be considered a propagated signal. Operating software 707 comprises computer programs, firmware, or some other form of machine-readable processing instructions. Operating software 707 includes extraneous voice module 708. Operating software 707 may further include an operating system, utilities, drivers, network interfaces, applications, or some other type of software. When executed by processing circuitry 705, operating software 707 directs processing system 703 to operate computing architecture 700 as described herein.

In particular, extraneous voice module 708 directs processing system 703 to receive audio captured from an endpoint operated by a user on a communication session. Extraneous voice module 708 further directs processing system 703 to identify an extraneous voice in the audio, wherein the voice is from a person other than the user, and remove the extraneous voice from the audio. After removing the extraneous voice, extraneous voice module 708 directs processing system 703 to transmit the audio to another endpoint on the communication session.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

1. A method comprising:
receiving audio comprising a signal representing sound captured from an endpoint operated by a user on a communication session;
identifying an extraneous voice in the audio, wherein the voice is from a person other than the user;
removing the extraneous voice from the audio; and
after removing the extraneous voice, transmitting the audio to another endpoint on the communication session.

2. The method of claim 1, wherein identifying and removing the extraneous voice comprise:
inputting the audio into a machine learning algorithm, wherein the machine learning algorithm is trained to recognize a user voice of the user and wherein the machine learning algorithm outputs the audio with the extraneous voice removed.

3. The method of claim 2, comprising:
training the machine learning algorithm using one or more samples of the user voice.

4. The method of claim 3, wherein training the machine learning algorithm includes:
in response to the user initiating the communication session, requesting the samples from the user.

5. The method of claim 3, wherein training the machine learning algorithm comprises:
training the machine learning algorithm using one or more extraneous voice samples that were not intended for transmittal.

6. The method of claim 3, wherein the machine learning algorithm generates a confidence score for the extraneous voice and removes the extraneous voice upon determining that the confidence score satisfies a threshold level of confidence.

7. The method of claim 6, wherein the machine learning algorithm considers intensity of the extraneous voice and/or a language spoken by the extraneous voice when generating the confidence score.

8. The method of claim 1, comprising:
notifying the user that the extraneous voice has been identified;
wherein removing the extraneous voice is performed in response to determining that the user has granted permission for removal of the extraneous voice.

9. The method of claim 1, wherein identifying the extraneous voice comprises:
isolating the extraneous voice from one or more other voices in the audio.

10. The method of claim 1, wherein the extraneous voice is not a voice included in a whitelist of voices.

11. An apparatus comprising:
one or more computer readable storage media;
a processing system operatively coupled with the one or more computer readable storage media; and
program instructions stored on the one or more computer readable storage media that, when read and executed by the processing system, direct the processing system to:
receive audio comprising a signal representing sound captured from an endpoint operated by a user on a communication session;
identify an extraneous voice in the audio, wherein the voice is from a person other than the user;
remove the extraneous voice from the audio; and
after removing the extraneous voice, transmit the audio to another endpoint on the communication session.

12. The apparatus of claim 11, wherein to identify and remove the extraneous voice, the program instructions direct the processing system to:
input the audio into a machine learning algorithm, wherein the machine learning algorithm is trained to recognize a user voice of the user and wherein the machine learning algorithm outputs the audio with the extraneous voice removed.

13. The apparatus of claim 12, wherein the program instructions direct the processing system to:
train the machine learning algorithm using one or more samples of the user voice.

14. The apparatus of claim 13, wherein to train the machine learning algorithm, the program instructions direct the processing system to:
in response to the user initiating the communication session, request the samples from the user.

15. The apparatus of claim 13, wherein to train the machine learning algorithm, the program instructions direct the processing system to:
train the machine learning algorithm using one or more extraneous voice samples that were not intended for transmittal.

16. The apparatus of claim 13, wherein the machine learning algorithm generates a confidence score for the extraneous voice and removes the extraneous voice upon determining that the confidence score satisfies a threshold level of confidence.

17. The apparatus of claim 16, wherein the machine learning algorithm considers intensity of the extraneous voice and/or a language spoken by the extraneous voice when generating the confidence score.

18. The apparatus of claim 11, wherein the program instructions direct the processing system to:
notify the user that the extraneous voice has been identified;
wherein removal of the extraneous voice is performed in response to determining that the user has granted permission for removal of the extraneous voice.

19. The apparatus of claim 11, wherein identifying the extraneous voice the program instructions direct the processing system to:
isolating the extraneous voice from one or more other voices in the audio.

20. One or more computer readable storage media having program instructions stored thereon that, when read and executed by a processing system, direct the processing system to:
receive audio comprising a signal representing sound captured from an endpoint operated by a user on a communication session;
identify an extraneous voice in the audio, wherein the voice is from a person other than the user;
remove the extraneous voice from the audio; and
after removing the extraneous voice, transmit the audio to another endpoint on the communication session.
